(19) United States
(12) Patent Application Publication
(10) Pub. No.: US 2020/0342486 A1
(43) Pub. Date: Oct. 29, 2020

(54) ONLINE DEALERSHIPS AND LOYALTY REWARDS

(71) Applicant: NRC Corporation, Atlanta, GA (US)

(72) Inventors: Amit Kumar, Bareilly (IN); Balaji Bandagi, Narayanpet (IN); Prerit Jain, Kaman (IN); Shubham Jain, Hyderabad (IN); Apoorva Jukanti, Hyderabad (IN); Pavani Lanka, Saradhi Nilayam (IN)

(21) Appl. No.: 16/397,566

(22) Filed: Apr. 29, 2019

(51) Int. Cl. G06Q 30/02; G06Q 30/06

(52) U.S. Cl. CPC G06Q 30/0227; G06Q 30/0605; G06Q 30/0222

(57) ABSTRACT

A system accumulates and pools the purchases of a product or service by many different customers, and when the number of units of the product or service exceeds a threshold, the product or service is sold to the many different customers at a threshold or wholesale price. The system further accumulates loyalty reward points for a customer from many different types of businesses, and stores and maintains these loyalty reward points for each customer in a single database.

### FIELD OF THE DISCLOSURE

The present disclosure generally relates to online dealerships and loyalty reward programs, and in an embodiment, but not by way of limitation, a system that permits the pooling of potential purchases from different customers to receive a wholesale or other price, and the accumulation of loyalty reward points in a single database for all customers for all different types of business entities.

### BACKGROUND OF THE DISCLOSURE

Loyalty systems generally relate to providing rewards to customers based on the amount of money that the customers spend on products and/or services. Such systems have been around for many years, but they seem to have grown in popularity with the advent of frequent flyer mile programs by the airlines. However, even though reward or loyalty systems have been in existence for many years, there is no system that permits a collection of all different types of systems' (like Retail/Restaurant/Gas Station/Entertainment) loyalty points in the same place. That is, there are separate loyalty systems for each of the domains (like Retails/Restaurant/Gas Station/Entertainment).

Additionally, ecommerce has been around for many years, and of course began to grow exponentially with the opening up of the Internet to virtually anyone and everyone. Today, such ecommerce sites can be wholesale in nature, retail in nature, or perhaps a combination of both wholesale and retail. Interestingly, for wholesale sites, they are somewhat like wholesale situations before the Internet, wherein a purchasing entity has to purchase a minimum amount of goods or services in order to get the wholesale price. That is, there is no available ecommerce platform wherein end customers can buy an individual, single, and/or only a few items at the wholesale price. Moreover, there are no sites that permits a manufacturer or supplier of goods and/or services to play a role as a virtual dealer (that is, there are no available plug-in or plug-out features for dealers online). As noted, of course there are many ecommerce sites available, but end customers can't buy single units at wholesale prices.

### BRIEF DESCRIPTION OF THE DRAWINGS

FIG. 1 shows an example embodiment of a system for providing wholesale prices to individual customers.

FIG. 2 shows an example embodiment of an integrated customer loyalty reward system.

FIGS. 3A and 3B show a flowchart of features and operations of an example embodiment of a system to permit a plurality of users to purchase goods at wholesale prices.

FIG. 4 shows a flowchart of features and operations of an example embodiment of an integrated loyalty reward system.

FIG. 5 shows an example embodiment of a computer system upon which one or more embodiments of the present disclosure can execute.

Corresponding reference characters indicate corresponding parts throughout the several views. Elements in the drawings are not necessarily drawn to scale. The configurations shown in the drawings are merely examples, and should not be construed as limiting the scope of the inventive subject matter in any manner.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, electrical, and optical changes may be made without departing from the scope of the present invention. The following description of example embodiments is, therefore, not to be taken in a limited sense, and the scope of the present invention is defined by the appended claims.

In an embodiment, a system creates and showcases “wholesale deals” to individual and other end customers and/or retailers using a third-party platform over ecommerce. The embodiment includes a tool, and/or service, and/or a web application that makes use of the third-party platform wherein manufactures/suppliers and end customers are connected via the platform. Specifically, by making use of available information such as sale deals provided by the manufacturer, and the consumer area interest, the platform creates attractive e-deals (via artificial intelligence (AI) and/or user interfaces to create deals). The platform can be implemented such that manufacturers subscribe to a service to sell their goods in bulk amounts to a plurality of customers, which are accumulated by the platform, and through this accumulation the manufacturer can offer a wholesale price to the plurality of customers, even down to a single customer who purchases only a single unit. The platform is therefore basically the next step in the sharing economy.

For example, for a purchaser to normally receive the wholesale price, the purchaser may have to purchase twenty computer monitors for the wholesale price of $900 per monitor. However, the platform can keep track of an aggregate number or amount of monitors that the plurality of customers indicates are desired to be purchased, and when the number of monitors equals or exceeds the twenty units, the system can then arrange for the sale of the block of those monitors to the plurality of customers, and provide the wholesale price to each one of those customers.

The platform creates these e-deals and offers using data provided by the manufacturer, the supplier, and/or the customer. By subscribing to the platform service, manufacturers/suppliers can provide goods to individual customers at wholesale prices and individual customers can buy down to a single item of the good and pay the wholesale price. Simply put, the platform pools customers who are requesting to purchase the same product(s). Once the product's sum reaches the minimum number of goods, which can be referred to as the pool size, the platform automatically fills the orders for the customers who indicated that they would like to purchase the product, and the customers receive the wholesale price.

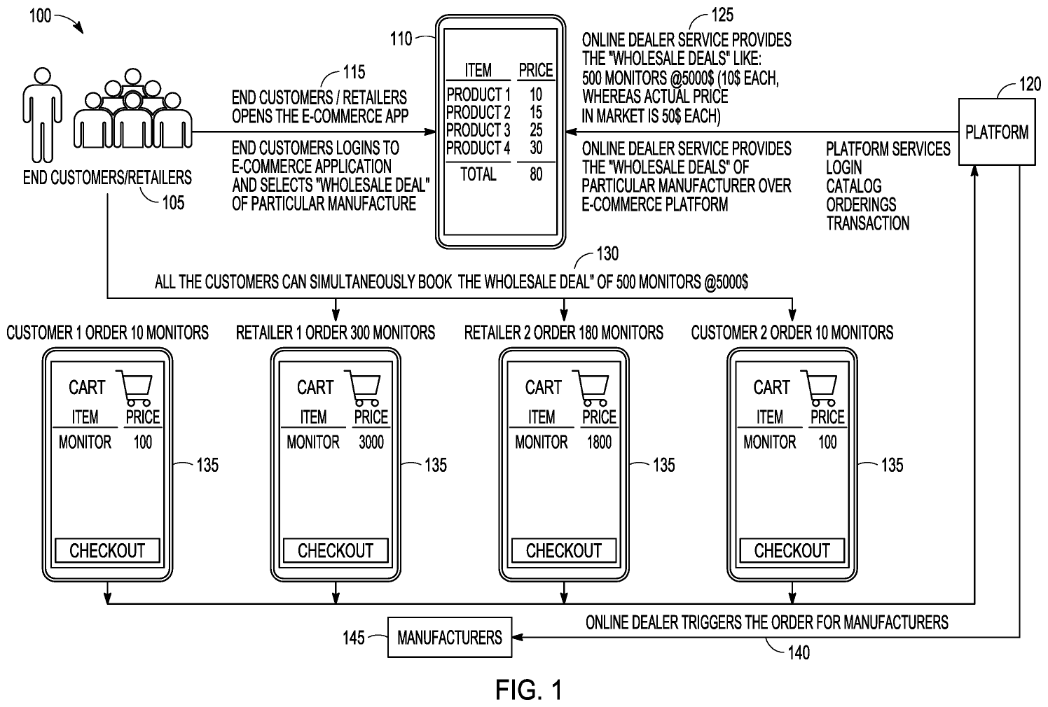

Referring to FIG. 1, a customer/dealer system 100 includes a platform server 120. The platform processes logins of customers, maintains catalogs of the goods that are available for wholesale purchase, receives orders or indications from the customers that they are interested in purchasing a particular good, accumulates these orders for the particular goods, and arranges for the transmission of the goods to each of the plurality of customers.

The end retailers or customers 105 at 115 open an ecommerce app 110, login to the ecommerce platform, and indicate that they would like to purchase a particular product that is subject to a wholesale deal offered by the platform. In response, the platform server 120 provides the particular wholesale deals of a particular manufacturer/supplier for a particular good/service over the ecommerce platform. For example, as illustrated in FIG. 1, at 125, the wholesale deal may be 500 computer monitors for $5000 (or $10 each, wherein the retail price is $50 each).

Then, as indicated at 130, the customers can order the wholesale deal for the computer monitors. These orders can be executed simultaneously, near simultaneously, or over a longer period of time such as a day or two or a work week, or even a longer period of time. For example, as indicated in FIG. 1, at 135, a first customer orders 10 monitors, a second customer orders 300 monitors, a third customer orders 180 monitors, and a fourth customer orders 10 monitors. The accumulated total of the first, second, third, and fourth customers adds up to 500 monitors—the threshold amount for the wholesale price to kick in. The platform server 120 recognizes the reaching of this threshold, and at 140 the platform server 120 triggers the order for the monitors from the manufacturer/supplier 145.

Another embodiment addresses the shortcomings of the prior art by creating a loyalty points system within an integrated loyalty system by scanning a quick response (QR) code of a plurality of receipts. The integrated loyalty rewards system can be useful in the case where a customer forgot to provide his/her details at the time of transaction. To address this situation, the customer simply scans the QR code on the receipt, and transits the QR code to the integrated loyalty reward system. The integrated loyalty system receives the QR code along with the customer information, and stores in in the customer's accumulated file as disclosed above.

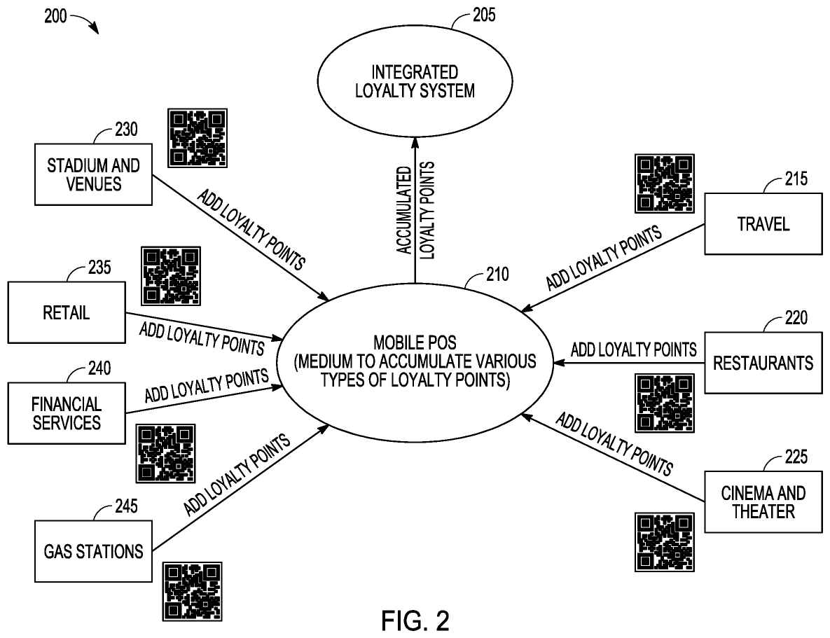

In another embodiment, an integrated loyalty reward system functions as follows. The loyalty reward points for each different retailer and/or each different type of retailer are accumulated and stored in a single location and/or database for each customer. This reduces unmanageable and separate loyalty reward systems into an integrated loyalty reward system. For example, as illustrated in FIG. 2, an integrated loyalty reward system 200 can include an integrated loyalty reward system server 205 that accumulates loyalty reward points, a user device 210 that accumulates various types of loyalty reward points from various types of business organizations, and the various types of business organizations such as stadiums and venues 230, retail stores 235, financial services 240, travel services 215, restaurants 220, and gas stations 245, and cinemas and theatres 225. These different business organizations generate an invoice or a receipt with a quick response (QR) code. The QR code includes the information about the total amount of the purchase and the total earned loyalty reward points that is associated with the amount of purchase. The customer scans the QR code using a scanning device, and the scanning device transmits the QR data to the integrated loyalty reward system. The integrated loyalty reward system updates the loyalty reward information in its database and transmits the updated loyalty point accumulation for that customer to the customer's device. In another embodiment, the customer need not scan a receipt or invoice. Rather, the point of sale terminal can transmit the loyalty point information directly to the integrated loyalty system.

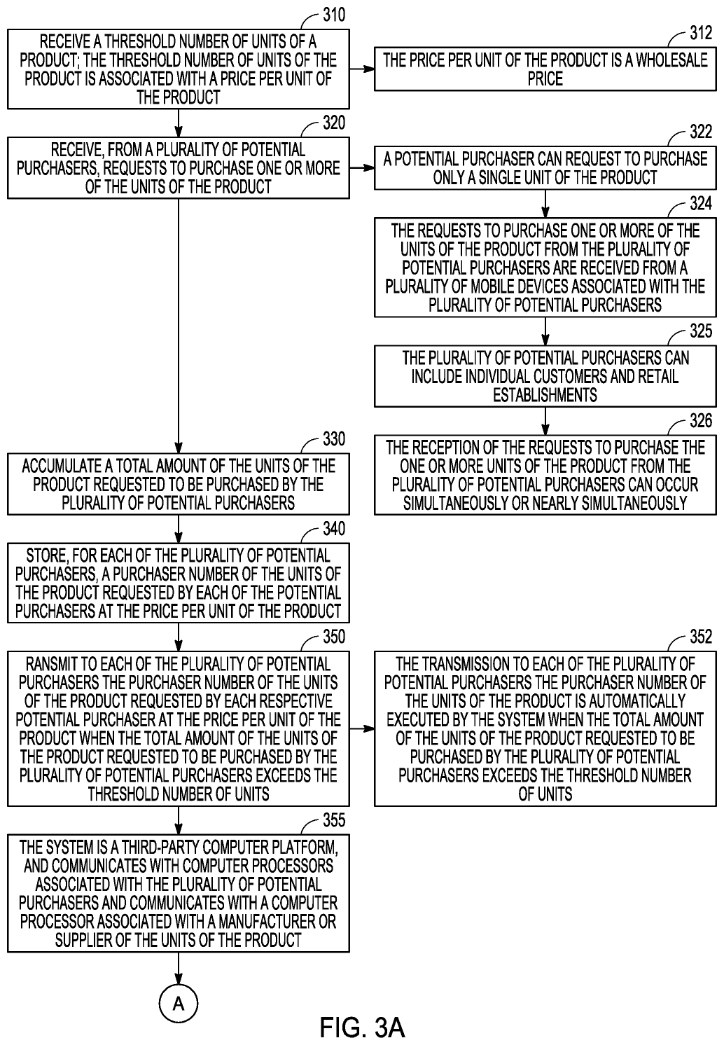

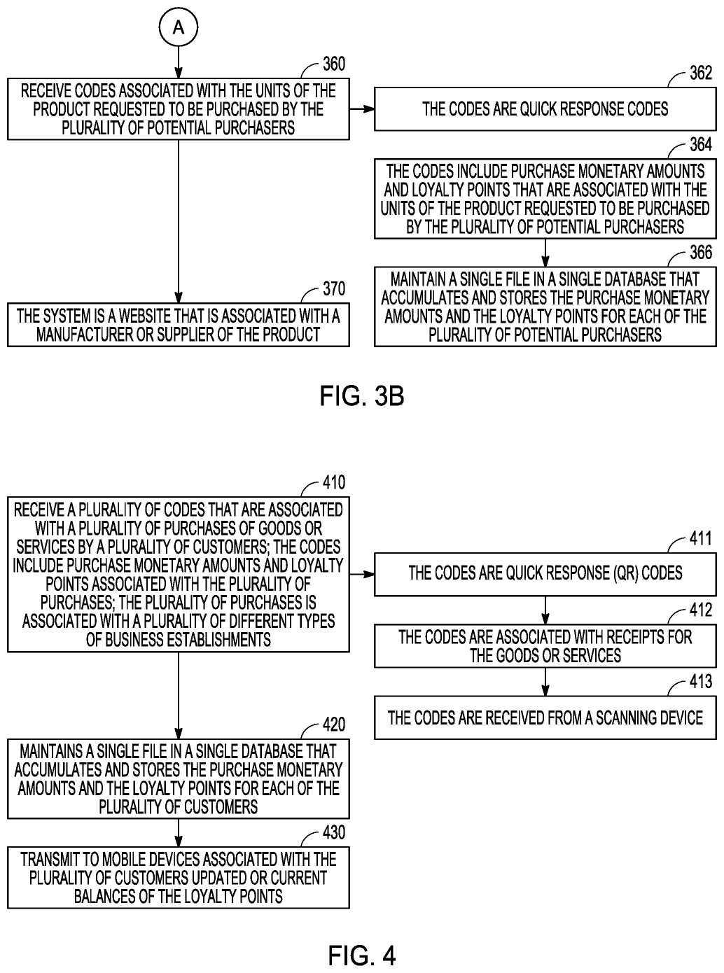

FIGS. 3A and 3B are a block diagram illustrating operations and features of a system and method for offering wholesale prices to individual customers, and FIG. 4 is a block diagram illustrating operations and features of a system and method for an integrated loyalty reward system. FIGS. 3A, 3B, and 4 include a number of blocks 310-360 and 410-430 respectively. Though arranged substantially serially in the example of FIGS. 3A, 3B, and 4, other examples may reorder the blocks, omit one or more blocks, and/or execute two or more blocks in parallel using multiple processors or a single processor organized as two or more virtual machines or sub-processors. Moreover, still other examples can implement the blocks as one or more specific interconnected hardware or integrated circuit modules with related control and data signals communicated between and through the modules. Thus, any process flow is applicable to software, firmware, hardware, and hybrid implementations.

Referring now to FIGS. 3A and 3B, at 310, a system receives a threshold number of units of a product. The threshold number of units of the product is associated with a price per unit of the product. As indicated at 312, the price per unit of the product is a wholesale price.

At 320, the system receives, from a plurality of potential purchasers via a computer network, requests to purchase one or more of the units of the product. As indicated at 322, a potential purchaser can request to purchase only a single unit of the product. As indicated at 324, the requests to purchase one or more of the units of the product from the plurality of potential purchasers are received from a plurality of mobile devices associated with the plurality of potential purchasers. As further indicated at 325, the plurality of potential purchasers can include individual customers and retail establishments. As noted at 326, the reception of the requests to purchase the one or more units of the product from the plurality of potential purchasers can occur simultaneously or nearly simultaneously.

At 330, the system accumulates a total amount of the units of the product requested to be purchased by the plurality of potential purchasers. At 340, the system stores, for each of the plurality of potential purchasers, a purchaser number of the units of the product requested by each of the potential purchasers at the price per unit of the product.

At 350, the system transmits to each of the plurality of potential purchasers the purchaser number of the units of the product requested by each respective potential purchaser at the price per unit of the product when the total amount of the units of the product requested to be purchased by the plurality of potential purchasers exceeds the threshold number of units. As indicated at 352, the transmitting to each of the plurality of potential purchasers the purchaser number of the units of the product is automatically executed by the system when the total amount of the units of the product requested to be purchased by the plurality of potential purchasers exceeds the threshold number of units

At 355, it is noted that the system is a third-party computer platform. The system or third party computer platform communicates with one or more computer processors associated with the plurality of potential purchasers. The system or third party computer platform further communicates with a computer processor associated with a manufacturer or supplier of the units of the product.

At 360, the system receives codes associated with the units of the product requested to be purchased by the plurality of potential purchasers. The codes can be quick response codes (362). The codes include purchase monetary amounts and loyalty points that are associated with the units of the product requested to be purchased by the plurality of potential purchasers (364). The units of the product requested to be purchased by the plurality of potential purchasers are associated with a plurality of different types of business establishments. Then, as indicated at 366, the system maintains a single file in a single database that accumulates and stores the purchase monetary amounts and the loyalty points for each of the plurality of potential purchasers.

As indicated at 370, the system can be a web site that is associated with a manufacturer or supplier of the product. This basically permits a manufacturer or supplier of the product to act as a virtual retailer of the product.

Referring now to FIG. 4, at 410, a system receives a plurality of codes that are associated with a plurality of purchases of goods or services by a plurality of customers. The codes comprise purchase monetary amounts and loyalty points associated with the plurality of purchases. The plurality of purchases is associated with a plurality of different types of business establishments. As indicated at 411, the codes are quick response (QR) codes, and as indicated at 412, the codes are associated with receipts for the goods or services. Normally, the system receives the plurality of codes from a scanning device (413).

At 420, the system maintains a single file in a single database that accumulates and stores the purchase monetary amounts and the loyalty points for each of the plurality of customers. At 430, the system transmits to mobile devices associated with the plurality of customers updated or current balances of the loyalty points.

### EXAMPLE EMBODIMENTS

Example No. 1 includes a process comprising receiving into a computer processor a threshold number of units of a product, the threshold number of units of the product associated with a price per unit of the product; receiving into the computer processor, from a plurality of potential purchasers via a computer network, requests to purchase one or more of the units of the product; accumulating a total amount of the units of the product requested to be purchased by the plurality of potential purchasers; storing, in the computer processor, for each of the plurality of potential purchasers, a purchaser number of the units of the product requested by each of the potential purchasers at the price per unit of the product; and transmitting to each of the plurality of potential purchasers the purchaser number of the units of the product requested by each respective potential purchaser at the price per unit of the product when the total amount of the units of the product requested to be purchased by the plurality of potential purchasers exceeds the threshold number of units.

Example No. 2 includes the features of Example No. 1, and optionally includes a process wherein the computer processor is associated with a third-party computer platform, wherein the computer processor communicates with one or more computer processors associated with the plurality of potential purchasers, and wherein the computer processor communicates with a computer processor associated with a manufacturer or supplier of the units of the product.

Example No. 3 includes the features of Example Nos. 1-2, and optionally includes a process wherein the price per unit of the product comprises a wholesale price.

Example No. 4 includes the features of Example Nos. 1-3, and optionally includes a process wherein one of more of the plurality of potential purchasers request to purchase a single unit of the product.

Example No. 5 includes the features of Example Nos. 1-4, and optionally includes a process including receiving, into the computer processor, codes associated with the units of the product requested to be purchased by the plurality of potential purchasers, wherein the codes comprise purchase monetary amounts and loyalty points associated with the units of the product requested to be purchased by the plurality of potential purchasers, and wherein the units of the product requested to be purchased by the plurality of potential purchasers are associated with a plurality of different types of business establishments; and maintaining a single file in a single database that accumulates and stores the purchase monetary amounts and the loyalty points for each of the plurality of potential purchasers.

Example No. 6 includes the features of Example Nos. 1-5, and optionally includes a process wherein the plurality of codes comprises a quick response (QR) code.

Example No. 7 includes the features of Example Nos. 1-6, and optionally includes a process wherein the computer processor is associated with a web site that is associated with a manufacturer or supplier of the product, thereby permitting the manufacturer or supplier of the product to act as a virtual retailer of the product.

Example No. 8 includes the features of Example Nos. 1-9, and optionally includes a process wherein the requests to purchase one or more of the units of the product from the plurality of potential purchasers are received from a plurality of mobile devices associated with the plurality of potential purchasers.

Example No. 9 includes the features of Example Nos. 1-8, and optionally includes a process wherein the transmitting to each of the plurality of potential purchasers the purchaser number of the units of the product is automatically executed by the computer processor when the total amount of the units of the product requested to be purchased by the plurality of potential purchasers exceeds the threshold number of units.

Example No. 10 includes the features of Example Nos. 1-9, and optionally includes a process wherein the plurality of potential purchasers comprises individual customers and retail establishments.

Example No. 11 includes the features of Example Nos. 1-10, and optionally includes a process wherein the receiving the requests to purchase the one or more units of the product from the plurality of potential purchasers occurs simultaneously or nearly simultaneously.

Example No. 12 includes a process comprising: receiving, into a computer processor, a plurality of codes associated with a plurality of purchases of goods or services by a plurality of customers, wherein the codes comprise purchase monetary amounts and loyalty points associated with the plurality of purchases, and wherein the plurality of purchases is associated with a plurality of different types of business establishments; and maintaining a single file in a single database that accumulates and stores the purchase monetary amounts and the loyalty points for each of the plurality of customers.

Example No. 13 includes the features of Example No. 12, and optionally includes a process wherein the plurality of codes comprises a quick response (QR) code.

Example No. 14 includes the features of Example Nos. 12-13, and optionally includes a process wherein the plurality of codes is associated with receipts for the goods or services.

Example No. 15 includes the features of Example Nos. 12-14, and optionally includes a process wherein the plurality of codes is received from a scanning device.

Example No. 16 includes the features of Example Nos. 12-15, and optionally includes a process comprising transmitting to mobile devices associated with the plurality of customers updated or current balances of the loyalty points.

Example No. 17 includes the features of Example Nos. 12-16, and optionally includes a process wherein the loyalty points are associated with a plurality of separate and distinct business entities.

Example No. 18 includes a non-transitory computer readable medium comprising instructions that when executed by a computer process executes a process comprising: receiving into a computer processor a threshold number of units of a product, the threshold number of units of the product associated with a price per unit of the product; receiving into the computer processor, from a plurality of potential purchasers via a computer network, requests to purchase one or more of the units of the product; accumulating a total amount of the units of the product requested to be purchased by the plurality of potential purchasers; storing, in the computer processor, for each of the plurality of potential purchasers, a purchaser number of the units of the product requested by each of the potential purchasers at the price per unit of the product; and transmitting to each of the plurality of potential purchasers the purchaser number of the units of the product requested by each respective potential purchaser at the price per unit of the product when the total amount of the units of the product requested to be purchased by the plurality of potential purchasers exceeds the threshold number of units.

Example No. 19 includes the features of Example No. 18, and optionally includes a non-transitory computer readable medium wherein the computer processor is associated with a third-party computer platform, wherein the computer processor communicates with one or more computer processors associated with the plurality of potential purchasers, and wherein the computer processor communicates with a computer processor associated with a manufacturer or supplier of the units of the product.

Example No. 20 includes the features of Example Nos. 18-19, and optionally includes a non-transitory computer readable medium comprising instructions for: receiving, into the computer processor, codes associated with the units of the product requested to be purchased by the plurality of potential purchasers, wherein the codes comprise purchase monetary amounts and loyalty points associated with the units of the product requested to be purchased by the plurality of potential purchasers, and wherein the units of the product requested to be purchased by the plurality of potential purchasers are associated with a plurality of different types of business establishments; and maintaining a single file in a single database that accumulates and stores the purchase monetary amounts and the loyalty points for each of the plurality of potential purchasers.

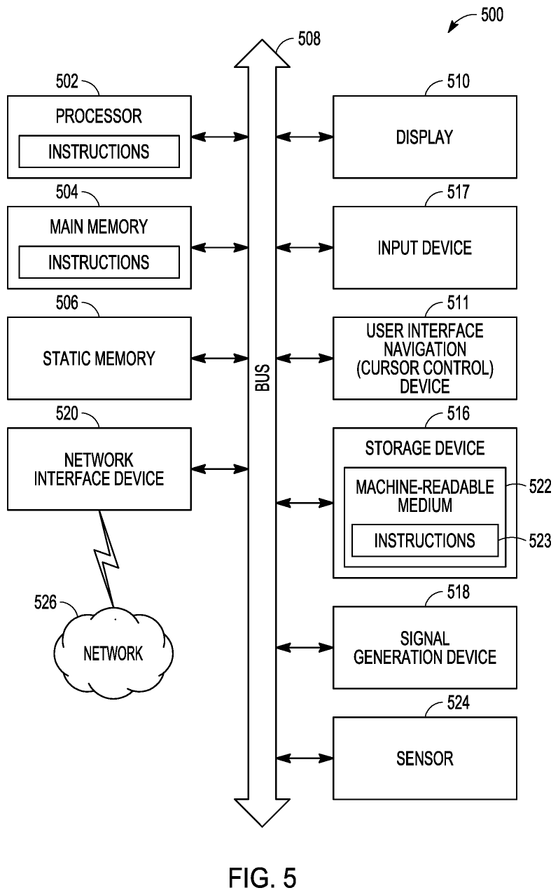

FIG. 5 is a block diagram of a machine in the form of a computer system within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in a client-server network environment, or as a peer machine in peer-to-peer (or distributed) network environment. In a preferred embodiment, the machine will be a server computer, however, in alternative embodiments, the machine may be a personal computer (PC), a tablet PC, a set-top box (STB), a Personal Digital Assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 500 includes a processor 502 (e.g., a central processing unit (CPU), a graphics processing unit (GPU) or both), a main memory 504 and a static memory 506, which communicate with each other via a bus 508. The computer system 500 may further include a display unit 510, an alphanumeric input device 517 (e.g., a keyboard), and a user interface (UI) navigation device 511 (e.g., a mouse). In one embodiment, the display, input device and cursor control device are a touch screen display. The computer system 500 may additionally include a storage device 516 (e.g., drive unit), a signal generation device 518 (e.g., a speaker), a network interface device 520, and one or more sensors 524, such as a global positioning system sensor, compass, accelerometer, or other sensor.

The storage device 516 includes a machine-readable medium 522 on which is stored one or more sets of instructions and data structures (e.g., software 523) embodying or utilized by any one or more of the methodologies or functions described herein. The software 523 may also reside, completely or at least partially, within the main memory 501 and/or within the processor 502 during execution thereof by the computer system 500, the main memory 501 and the processor 502 also constituting machine-readable media.

While the machine-readable medium 522 is illustrated in an example embodiment to be a single medium, the term “machine-readable medium” may include a single medium or multiple media (e.g., a centralized or distributed database, and/or associated caches and servers) that store the one or more instructions. The term “machine-readable medium” shall also be taken to include any tangible medium that is capable of storing, encoding or carrying instructions for execution by the machine and that cause the machine to perform any one or more of the methodologies of the present invention, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., EPROM, EEPROM, and flash memory devices; magnetic disks such as internal hard disks and removable disks; magneto-optical disks; and CD-ROM and DVD-ROM disks.

The software 523 may further be transmitted or received over a communications network 526 using a transmission medium via the network interface device 520 utilizing any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., Wi-Fi® and WiMax® networks). The term “transmission medium” shall be taken to include any intangible medium that is capable of storing, encoding or carrying instructions for execution by the machine, and includes digital or analog communications signals or other intangible medium to facilitate communication of such software.

It should be understood that there exist implementations of other variations and modifications of the invention and its various aspects, as may be readily apparent, for example, to those of ordinary skill in the art, and that the invention is not limited by specific embodiments described herein. Features and embodiments described above may be combined with each other in different combinations. It is therefore contemplated to cover any and all modifications, variations, combinations or equivalents that fall within the scope of the present invention.

The Abstract is provided to comply with 37 C.F.R. § 1.72(b) and will allow the reader to quickly ascertain the nature and gist of the technical disclosure. It is submitted with the understanding that it will not be used to interpret or limit the scope or meaning of the claims.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus the following claims are hereby incorporated into the Description of the Embodiments, with each claim standing on its own as a separate example embodiment.

What is claimed is:

1. A process comprising:
receiving into a computer processor a threshold number of units of a product, the threshold number of units of the product associated with a price per unit of the product;
receiving into the computer processor, from a plurality of potential purchasers via a computer network, requests to purchase one or more of the units of the product;
accumulating a total amount of the units of the product requested to be purchased by the plurality of potential purchasers;
storing, in the computer processor, for each of the plurality of potential purchasers, a purchaser number of the units of the product requested by each of the potential purchasers at the price per unit of the product; and
transmitting to each of the plurality of potential purchasers the purchaser number of the units of the product requested by each respective potential purchaser at the price per unit of the product when the total amount of the units of the product requested to be purchased by the plurality of potential purchasers exceeds the threshold number of units.

2. The process of claim 1, wherein the computer processor is associated with a third-party computer platform, wherein the computer processor communicates with one or more computer processors associated with the plurality of potential purchasers, and wherein the computer processor communicates with a computer processor associated with a manufacturer or supplier of the units of the product.

3. The process of claim 1, wherein the price per unit of the product comprises a wholesale price.

4. The process of claim 1, wherein one of more of the plurality of potential purchasers request to purchase a single unit of the product.

5. The process of claim 1, comprising:
receiving, into the computer processor, codes associated with the units of the product requested to be purchased by the plurality of potential purchasers, wherein the codes comprise purchase monetary amounts and loyalty points associated with the units of the product requested to be purchased by the plurality of potential purchasers, and wherein the units of the product requested to be purchased by the plurality of potential purchasers are associated with a plurality of different types of business establishments; and
maintaining a single file in a single database that accumulates and stores the purchase monetary amounts and the loyalty points for each of the plurality of potential purchasers.

6. The process of claim 5, wherein the plurality of codes comprises a quick response (QR) code.

7. The process of claim 1, wherein the computer processor is associated with a website that is associated with a manufacturer or supplier of the product, thereby permitting the manufacturer or supplier of the product to act as a virtual retailer of the product.

8. The process of claim 1, wherein the requests to purchase one or more of the units of the product from the plurality of potential purchasers are received from a plurality of mobile devices associated with the plurality of potential purchasers.

9. The process of claim 1, wherein the transmitting to each of the plurality of potential purchasers the purchaser number of the units of the product is automatically executed by the computer processor when the total amount of the units of the product requested to be purchased by the plurality of potential purchasers exceeds the threshold number of units.

10. The process of claim 1, wherein the plurality of potential purchasers comprises individual customers and retail establishments.

11. The process of claim 1, wherein the receiving the requests to purchase the one or more units of the product from the plurality of potential purchasers occurs simultaneously or nearly simultaneously.

12. A process comprising:
receiving, into a computer processor, a plurality of codes associated with a plurality of purchases of goods or services by a plurality of customers, wherein the codes comprise purchase monetary amounts and loyalty points associated with the plurality of purchases, and wherein the plurality of purchases is associated with a plurality of different types of business establishments; and
maintaining a single file in a single database that accumulates and stores the purchase monetary amounts and the loyalty points for each of the plurality of customers.

13. The process of claim 12, wherein the plurality of codes comprises a quick response (QR) code.

14. The process of claim 12, wherein the plurality of codes is associated with receipts for the goods or services.

15. The process of claim 12, wherein the plurality of codes is received from a scanning device.

16. The process of claim 12, comprising transmitting to mobile devices associated with the plurality of customers updated or current balances of the loyalty points.

17. The process of claim 12, wherein the loyalty points are associated with a plurality of separate and distinct business entities.

18. A non-transitory computer readable medium comprising instructions that when executed by a computer process executes a process comprising:
receiving into a computer processor a threshold number of units of a product, the threshold number of units of the product associated with a price per unit of the product;
receiving into the computer processor, from a plurality of potential purchasers via a computer network, requests to purchase one or more of the units of the product;
accumulating a total amount of the units of the product requested to be purchased by the plurality of potential purchasers;
storing, in the computer processor, for each of the plurality of potential purchasers, a purchaser number of the units of the product requested by each of the potential purchasers at the price per unit of the product; and
transmitting to each of the plurality of potential purchasers the purchaser number of the units of the product requested by each respective potential purchaser at the price per unit of the product when the total amount of the units of the product requested to be purchased by the plurality of potential purchasers exceeds the threshold number of units.

19. The non-transitory computer readable medium of claim 18, wherein the computer processor is associated with a third-party computer platform, wherein the computer processor communicates with one or more computer processors associated with the plurality of potential purchasers, and wherein the computer processor communicates with a computer processor associated with a manufacturer or supplier of the units of the product.

20. The non-transitory computer readable medium of claim 18, comprising instructions for:
receiving, into the computer processor, codes associated with the units of the product requested to be purchased by the plurality of potential purchasers, wherein the codes comprise purchase monetary amounts and loyalty points associated with the units of the product requested to be purchased by the plurality of potential purchasers, and wherein the units of the product requested to be purchased by the plurality of potential purchasers are associated with a plurality of different types of business establishments; and
maintaining a single file in a single database that accumulates and stores the purchase monetary amounts and the loyalty points for each of the plurality of potential purchasers.
